(19) United States
(12) Patent Application Publication
(10) Pub. No.: US 2008/0074497 A1
(43) Pub. Date: Mar. 27, 2008

(54) Method and Apparatus for Determining and Displaying Signal Quality Information on a Television Display Screen

(75) Inventor: Steve Kuh, Los Angeles, CA (US)

Correspondence Address: MORGAN LEWIS & BOCKIUS LLP, 1111 PENNSYLVANIA AVENUE NW, WASHINGTON, DC, 20004, US

(73) Assignee: KTECH TELECOMMUNICATIONS, INC., Chatsworth, CA (US)

(21) Appl. No.: 11/534,145

(22) Filed: Sep. 21, 2006

(51) Int. Cl. H04N 17/02

(52) U.S. Cl. 348/180

(57) ABSTRACT

A method and apparatus for determining and displaying signal quality measurement on a television display screen. The method and apparatus of this invention provides for the display of signal quality measurements, including measurements of signal-to-noise ratio, bit error rate and channel multi-path distortion in addition to the signal strength. Furthermore, apparatus are described and methods described whereby these signal quality measurements may be ascertained and provided either through television overlay or through NTSC radio frequency modulation to particular television channels.

### 1. FIELD OF THE INVENTION

The present invention relates televisions and signal quality and more specifically to a method and apparatus for determining and displaying signal quality measurement on a television display screen.

### 2. BACKGROUND OF THE INVENTION

The prior art describes methods of creating a visual display of the level of signal quality that is present for a given television signal. In these type of prior art methods and apparatus, the signal display is typically given as a meter, ranging from a low level to a high level. In the prior art, no actual indication of numerical values are given. While these meters let users of the television know the relative signal strength of the signal, they provide very limited and very “rough” estimates of a signal's overall quality.

Also present in the prior art additional meters which provide bars, similar to those now employed for use in cellular and other mobile phone technology. These provide that a display will show additional bars or “taller” bars when the signal strength is high and fewer or “smaller” bars when the signal strength is low. Again, this type of prior art fails to provide meaningful numeric measures of the quality of the signal, not simply for the user but for other people or television customer service who may need numeric values.

Also in the prior art are methods which provide means for outputting direct overlays of multi-path distortion measures to the display of the television. This prior art only provides multi-path distortion measures and does not provide alternative means of output. While multi-path distortion measures are one of the most important measures of signal quality (as opposed to signal strength) for modern televisions, they are not the only measure necessary for good customer service and user information.

Finally, there is in the prior art a method of providing an on-screen display of the signal strength of various channels. These methods provide an interactive guide on screen whereby a user may view signal strength per channel. This method does not provide any other measure of signal quality (as opposed to signal strength) and does not provide alternative means for displaying the information.

In the known prior art, there is no method or apparatus that provides means whereby multiple indicators of signal quality (as opposed to signal strength) are displayed simultaneously and furthermore whereby those indicators may be displayed either as an overlay for HDTV televisions using an MPEG-2 decoder or, alternatively, utilize a radio frequency modulator on the MPEG-2 decoded video output, causing the display to be made on standard NTSC channel 3 or 4.

It is therefore an object of this invention to provide a method and apparatus that is capable of delivering multiple elements of signal quality measurements with accuracy. It is a further object of the present invention to provide these measurements directly to the consumer (and secondarily to customer support specialists) through on screen displays or alternatively through NTSC channel 3 or 4. These and other objects of the present invention will be seen from the following description.

### BRIEF SUMMARY OF THE INVENTION

The method and apparatus of this invention overcome the limitations of the prior art by taking information and data available to a television receiver and making it available to a user of that television. The present invention provides means of gathering and displaying signal strength, signal-to-noise ratio (SNR), bit error rate (BER) and channel multi-path distortion simultaneously (or substantially simultaneously).

Furthermore, the method and apparatus of this invention provides means by which this data may be displayed, using an RF modulator, on any channel. In the preferred embodiment, the data is displayed on channels 3 and 4. Alternatively, an MPEG-2 decoder and HD Video output directly to the display may be used, for example, as an overlay or as a portion of a display.

Furthermore, the method and apparatus of this invention provides means by which the signal quality indication is provided in means of graph (or bar levels) and/or in means of actual signal quality measurements using numbers measured by the television hardware.

### BRIEF DESCRIPTION OF THE DRAWINGS

FIG. 1 is a depiction of an example signal quality measurement.

FIG. 2 is a depiction of one method of gathering signal quality information.

FIG. 3 is a depiction of another method of gathering signal quality information.

FIG. 4 is a depiction of another method of gathering signal quality information.

### DETAILED DESCRIPTIONS OF THE INVENTION

Herein there are numerous terms used which are described in the art through the use of acronyms. Furthermore, there are additional terms that need to be defined for purposes of the specification and claims. These terms are defined below. Wherever “video” is used herein, it is to be understood that video includes transmissions or displays that are video only, audio and video in conjunction and those that are completely or primarily audio. High definition may be described using the acronym “HD” in various places within the specification. The two terms are intended to be synonymous. The acronym “NTSC” refers to the National Television Systems Committee, a committee established by the Federal Communications Commission that is responsible for setting television transmission and display standards. The acronym “ATSC” refers to the Advanced Television Systems Committee. The acronym “MPEG” refers to the Motion Picture Experts Group. The acronym “MPEG-2” refers to the standard adopted by the Motion Picture Experts Group with regard to a compression and coding standards for audio video content. The acronym “RF” refers to radio frequency. These definitions are important for understanding the remainder of the specification.

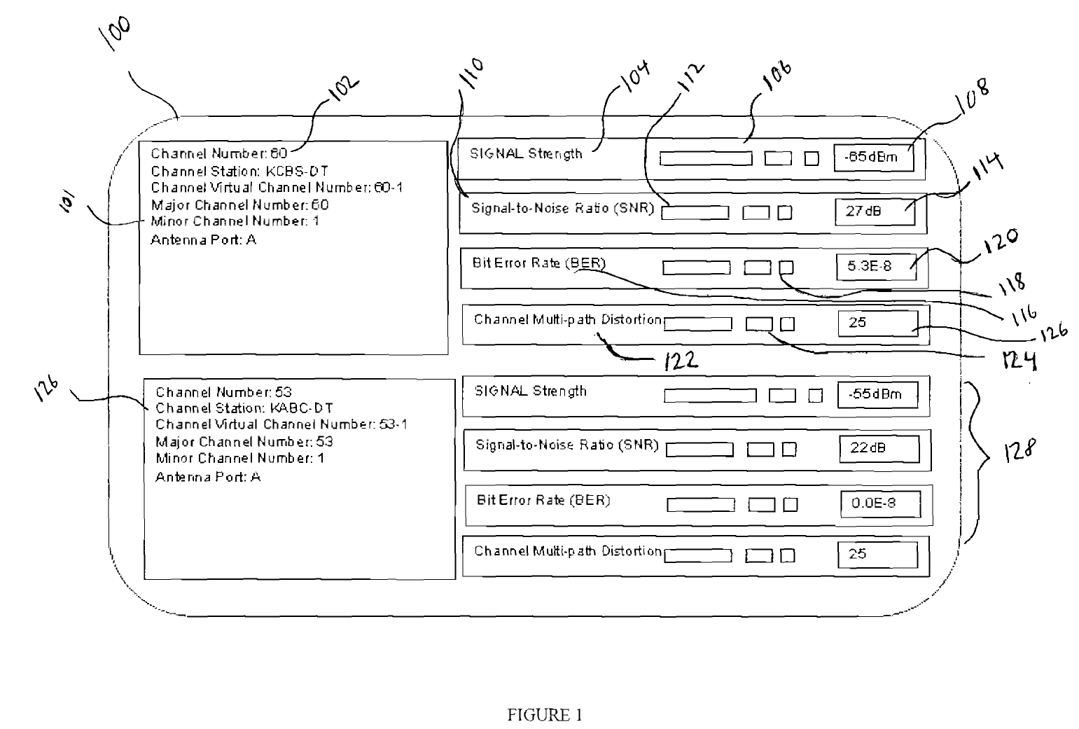

Referring first to FIG. 1, a depiction of an example display of the present invention is depicted. This is an example of the type of display that can be used with the method and apparatus of this invention to provide the information described. It is to be understood that this display is merely for illustrative purposes and that any type, arrangement or visual embellishment may be used that substantially accomplishes similar purposes.

The display 100 includes a channel box 101. The channel box 101 may take many forms and may include more or less information than the channel box 101 provided in this preferred embodiment. However, the channel box 101 in this display 100 of the preferred embodiment provides several types of information, most notably, the channel number, seen in element 102.

In order to adequately provide signal quality information, multiple facets of the signal quality must be shown. Signal quality is a measure of the ability of the television receiver to receive, decode and present the video that is being broadcast by way of a particular method of broadcast. Signal strength is, only, the power in micro-watts, milli-watts, micro-volts, milli-volts, or equivalently decibel-relative to 1 micro-watts (dBu), milli-watts (dBm), micro-volts (dBuV), milli-volts (dBmV) of the signal at the point of reception by the antenna. Signal quality, as used in the preferred method of this invention is a combining of information about signal strength, signal-to-noise ratio, bit error rate and channel multi-path distortion. The combination of these elements provides a much more complete picture as to the probable quality of the video display. Furthermore, by providing multiple measures of quality, instead of the typical single measure, it enables users and customer service representatives to more quickly and accurately pinpoint problems with television reception and display.

With regard to this channel number 102, several things are displayed in the preferred embodiment. First, the signal strength 104 is displayed. The first indicator of signal strength level is provided in the form similar to the prior art, a bar, as seen in element 106. However, not seen before in the prior art is the numerical value of the signal strength, as shown in element 108. Also in the preferred embodiment of the invention, the signal-to-noise ratio (SNR) 110 is depicted. For this element of signal quality, the television provides output of the ratio of the signal power, as descernable by the television receiver, to the noise power or background always-present non-signal interference power. This provides information about whether there is simply too much interference between the transmitter and the receiving antenna to adequately render the television signal received. Similarly to above, a bar indicator of the quality, provided as a relative measure is depicted in element 112. Additionally, the numerical value of the signal-to-noise ratio is provided, as shown in element 114.

Next, element 116 depicts the bit error rate (BER). This is the ratio of bits with errors over the total number of bits sent or received. Here, the bit error rate, as above, has a bar or meter, shown in element 118. Also depicted is the numeric value of the BER present in element 120.

Finally, the channel multi-path distortion is depicted in element 122. This is the distortion in the received television signal as a result of multiple signals being received simultaneously (or substantially so) after bouncing off of trees, hills, buildings, and the like during its physical travel between the television signal transmitting location and the television signal receiving location. These create multi-path signals, whereby multiple paths (each with different travel distances and times) are made for one signal to the antenna. This can also result in signal distortion or loss of signal altogether depending on the extent to which the multiple paths interfere with each other or are substantially out-of-synchronization. As above, the channel multi-path distortion 122 includes a bar or meter measure, depicted in element 124 and a numerical value 126.

Similarly, a channel box 126 (like the one in element 101) is provided for each channel. The indicators of signal quality 128 are also provided for each channel. These, in the preferred embodiment include names, bars or other visual indicators of signal quality and numerical values.

In each case, the numerical value is most useful to customer service or knowledgeable users. The reason for providing multiple indicators of signal quality, as opposed to simply a measure of signal strength or one of the other measures of signal quality is to allow for more precise understanding of problems that can and do occur with signal reception. By providing this information to users of the product, knowledgeable users will be able to more-readily understand the problems affecting their reception.

The usefulness of this information may be more readily understood by way of an example. A new customer for a television purchases that television and takes it home. He installs the television, hooking it up in the proper manner and turns it on. His anticipation of the new television, particularly High-Definition (HD) television, is high. He envisions watching the upcoming Sunday game in high definition and he is happy.

As it turns out, the television has no reception of the station he wishes to watch. In the methods of the prior art, he may, at most, receive an indicator of the signal strength or alternatively of the channel multi-path distortion. In the prior art, neither of these two indicators are provided simultaneously. So, in the example, he is using a traditional television antenna to receive the signal. He reviews the signal strength and determines, through the “bar” or “meter” indicator that his signal strength is high.

A strong signal is not the only indicator of a good signal quality. A good signal quality is achieved through the combination of numerous factors, not the least of which is signal strength. However, if there is large channel multi-path distortion, a high bit error rate or low signal-to-noise ratio (or any combination of the three), a strong signal will be unimportant. A signal may be very strong, yet horribly distorted or having very high error rates. Similarly, if one may only see bit error rates, the signal strength may be too weak to receive the signal accurately. Any one of the four suggested measures of signal quality provided in the preferred embodiment of this invention may be sufficient to drastically degrade signal quality.

As is known in the art, high definition digital television signals in particular experience what is known as a “cliff effect.” The cliff effect is generated as a result of the way in which high definition signals are sent. High definition signals utilize encoding such that even if there is a fairly high level of signal corruption (through distortion, low signal strength, high bit error rates or multi-path distortion), later portions of the signal or earlier portions provide what is in effect “checksums” for correcting the “missing” or corrupted pieces of the signal. Therefore, even with a very low signal quality, modern high definition signals may be pieced back together by the receiver and appear to all viewers to be crystal clear.

The cliff effect occurs at the point at which the signal quality surpasses a certain point of degradation at which the receiver is incapable of reassembling the portions of the signal that have been corrupted or are missing. There is absolutely no on-screen diminution of the visible quality of the reception until this point is reached. At this point, the signal immediately is indiscernible by the television receiver. A user turning his antenna would experience this as crystal-clear high definition signal for some portion of a rotation of a large antenna and absolutely nothing or fuzzy reception for the remaining portion. There is no “fading” of the visible quality of the reception on the screen.

Because of this cliff effect, the method and apparatus of this invention are all the more important. The method of this invention provides means by which a user of this information could determine what, exactly, is causing the receiver to be unable to view the signal. In the past, users of televisions could simply view the signal and see the reception becoming better or worse as they turn the antenna. Modernly, the high definition televisions do not do this, so numerical values and indicators provided readily to the user of the product are necessary.

Returning to the example, if the purchaser of the high definition television including the preferred method and apparatus of this invention has access to these indicators of signal quality, he may quickly see the limiting factor in his reception of a particular channel. For example, he may notice that the signal strength is great, but that there is a very high channel multi-path distortion. In that case, one alternative would be to raise the antenna higher so as to get a more direct shot at the television station's broadcast tower. Alternatively, he may see that the signal-to-noise ratio is very low. In this case, he could purchase a “booster” or an RF amplifier for his antenna.

In the absence of these indicators (and readily visible alerts that are available to the users) the purchaser in the example may simply believe he has purchased a faulty product. This provides the expectant (and initially happy) purchaser with an immediate bad experience with his product. Furthermore, he lacks any tools to appropriately deal with the problem. Therefore, he may simply return his newly-purchased digital television or digital television converter box, resulting in wasted time for him and lost profits for the television manufacturer and retailer.

Additionally, providing this information, even to those who do not understand these measures of signal quality will provide options to a remote troubleshooter in dealing with the poor reception. A remote customer service person would be able to request this information, if it is available using the preferred method and apparatus of this invention, and provide much more pointed feedback and response. In its absence or the inclusion only of signal strength, the customer service representative would see, in the worst case scenario, that there is excellent signal strength, but that there is no visible image. The customer service representative would, therefore, have little alternative and little knowledge upon which to begin working to troubleshoot a problem. This hinders the ability of the customer service representative to help the customer, slows progress and provides an additional negative experience to a previously happy customer.

These signal quality measurements may be made available to any number of extra connections provided on the television (such as FireWire, IEEE, HDMI, etc). Additionally, this information may be provided as an overlay as a video signal, radio frequency modulated using NTSC methods for a particular channel (in this example NTSC channel 3 or 4) and display the signal quality measurement on the NTSC analog television screen using its analog NTSC channel 3 or 4.

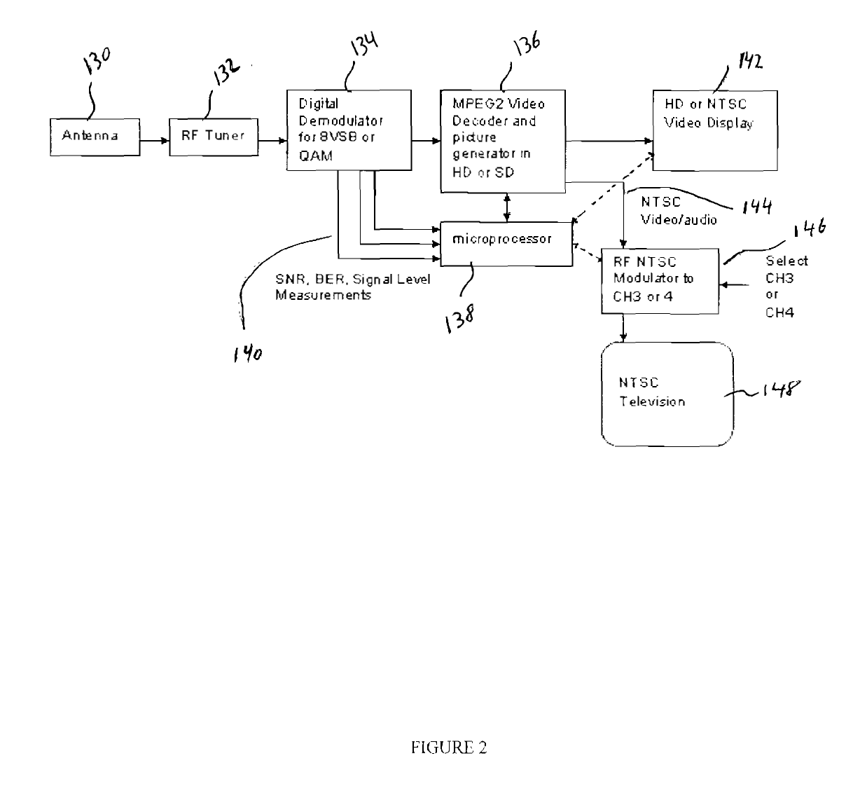

Referring now to FIG. 2, one embodiment of the method and apparatus of this invention is depicted. This is a connection depiction of one of the embodiments of this invention. The first element depicted is the antenna 130. This element is, as is well-known in the art, responsible for receiving the broadcast signal. This antenna 130 would receive a standard American Television Systems Committee (ATSC) digital television signal.

Next, a radio frequency turner 132 is depicted. This tuner would be used to select a channel and provide gain and frequency references to generate an intermediate frequency for use with the next element. Next, a digital demodulator 134, such as an 8VSB or QAM digital demodulator is used. These are described in the ATSC digital television specifications for A/53 compliant digital television signals. From this digital demodulator 134, several pieces of information may be taken. These include the three depicted in element 140, SNR, BER and signal level measurements. These represent the signal-to-noise ratio, bit error rate and signal strength respectively. These pieces of information are available in most modern A/53 compliant devices that perform digital demodulation of radio frequency signals. In the prior art, no method is known whereby this information is provided to the end user for viewing.

These pieces of information are provided to a microprocessor 138. The microprocessor, in turn, provides information sufficient to render these pieces of information to, in the preferred embodiment, an MPEG-2 video decoder 136. The MPEG-2 video decoder 136 then generates video for the display of this information. In alternative embodiments, the microprocessor may be designed in such a way as to be able, itself, to provide the information sufficient to generate video for the display of the signal quality information. Such a microprocessor may be a general-purpose microprocessor or a graphical processing unit (GPU) or other suitable processors. In these embodiments the microprocessor would communicate directly with the HD or NTSC video display or the radio frequency modulator. The video information is then displayed on the HD or NTSC video display 142 through its baseband video format. Alternatively or additionally, the video may be provided in the form of NTSC video/audio 144 to a radio frequency modulator in element 146 to be displayed on channel 3 or 4 on a NTSC Analog Television 148.

The information displayed through the method of this invention will resemble the example output displayed in FIG. 1. The extracted information provided in this embodiment are only the signal-to-noise ratio, the bit error rate and the signal strength. This embodiment, while not depicting the channel multi-path distortion, still provides additional information not available in the prior art methods. These pieces of information are sufficient to greatly increase a user's or customer service representative's ability to troubleshoot or understand the nature of the television signal available to the television.

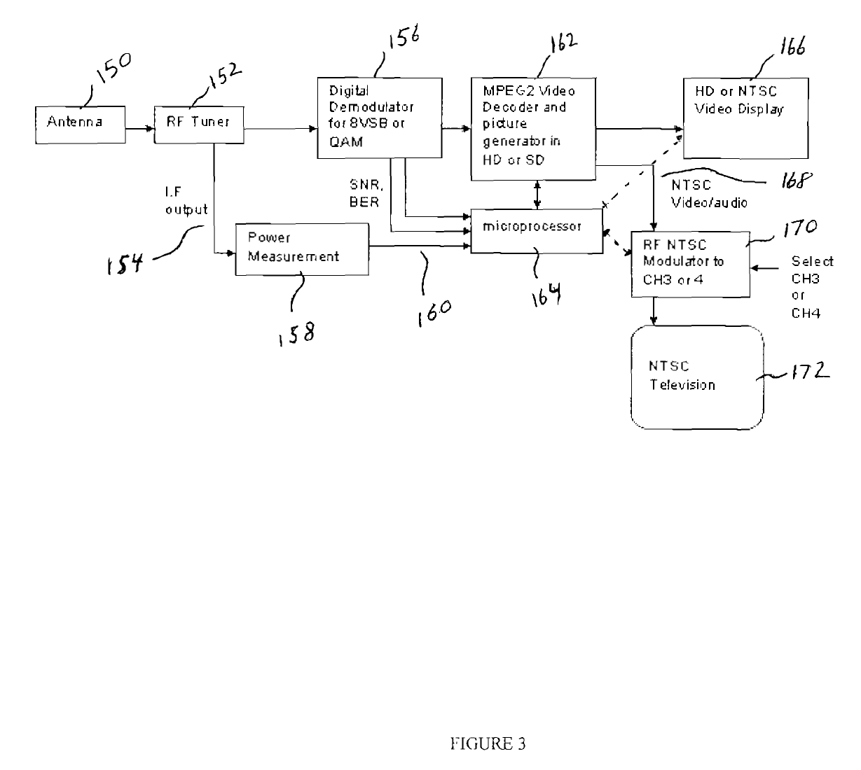

Referring now to FIG. 3, a similar method is depicted. As above, there is an antenna 150 and a radio frequency (RF) tuner 152. Here, the RF tuner 152 generates an intermediate frequency (IF) output 154. This IF output 154 is used, in conjunction with a squaring means, a log means, or by taking the sum of squares of in phase and quadrature phase baseband signal, to derive a power measurement 158 of the signal. This power level, taken from the RF tuner 152 is compared with the gain introduced within the RF tuner 152 to determine the original signal strength.

The digital demodulator 156 is used, as in the prior embodiment, to derive the signal-to-noise ratio and bit error rate. These, along with the derived signal strength are provided (as seen in element 160) to the microprocessor 164. As above, the MPEG-2 video decoder 162 is used in conjunction with the microprocessor 164 to generate video signal to be displayed on the HD or NTSC video display 166. As above, the microprocessor may be capable of generating a video signal itself. As described above, the video signal may instead be routed through a radio frequency modulator 170 for NTSC signals, and subsequently displayed on channel 3 or 4 of an NTSC television 172.

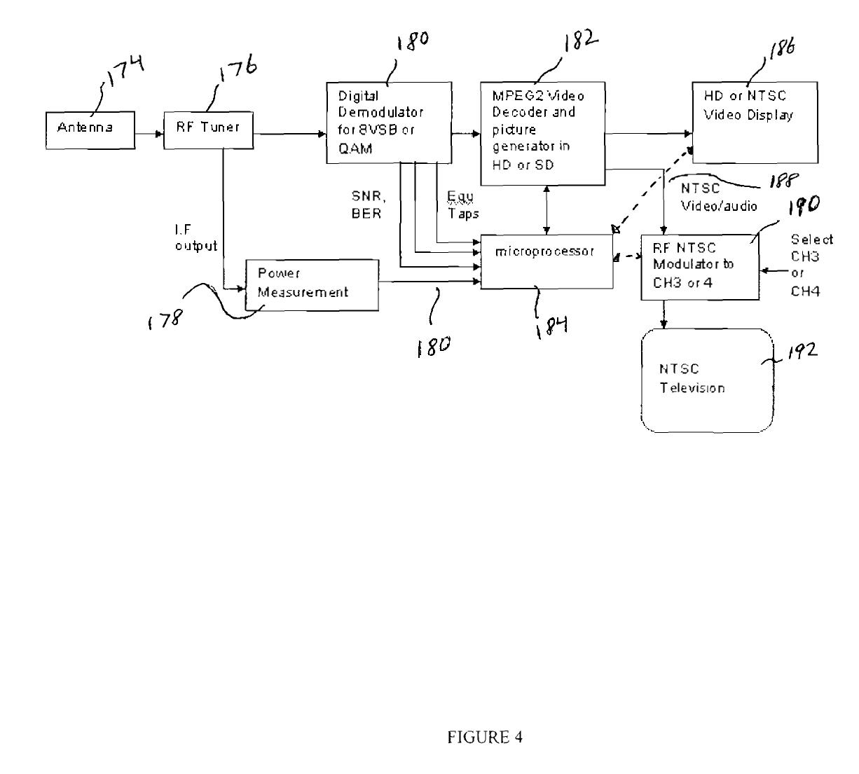

In FIG. 4, yet another alternative embodiment of the present invention is depicted. In this embodiment, the antenna 174 is also shown, along with the RF tuner 176 present in FIGS. 2 and 3. This method employs the power measurement 178 method and apparatus described with reference to FIG. 3. However, in an alternative embodiment of this embodiment, the original power measurement means provided for in the description with reference to FIG. 2 may also be used. Additionally, a digital demodulator 180 for 8VSB or QAM is depicted. The digital demodulator 180 is used to provide the signal-to-noise ratio and the bit error rate, as in the previously described embodiments.

In this embodiment, however, channel multi-path distortion is provided through the inclusion of a weighted average of the equalizer tap weights of the digital demodulator 180. It is also possible to measure the channel multi-path distortion through other means such as non-weighted, least-squared average, non-average, sub-sample, sum of squares of squares, a simple sum of squares, a random sum of squares, or other mathematical similar operating means of the equalizer tap weights of the digital demodulator, These four elements, the signal power, signal-to-noise ratio, bit error rate and channel multi-path distortion (derived through the weighted average or other mathematical means of the equalizer tap weights) are provided to the microprocessor 184 as seen in element 180.

The microprocessor, as before, provides this information to the MPEG-2 video decoder 182 to be converted into video signal. As above, the microprocessor may create the video signal itself. This may be displayed directly on an HD or NTSC video display 186 (for example as an overlay). Alternatively, as above, the NTSC video/audio 188 may be provided to an RF NTSC modulator 190 wherein it is converted into channel data and its signal quality indication to be displayed on an NTSC television 192 on channel 3 or 4.

It will be apparent to those skilled in the art that the present invention may be practiced without these specifically enumerated details and that the preferred embodiment can be modified so as to provide additional or alternative capabilities. The foregoing description is for illustrative purposes only, and that various changes and modifications can be made to the present invention without departing from the overall spirit and scope of the present invention. The present invention is limited only by the following claims.

What is claimed is:

1. A method for determining and displaying the signal quality of a television signal, comprising the steps of:
gathering at least two of the following indicators of signal quality from a received radio frequency television signal:
a) signal strength of the television signal;
b) bit error rate of the television signal;
c) signal-to-noise ratio of the television signal; or
d) channel multi-path distortion of the television signal;
processing each of said gathered indicators of signal quality; and
displaying a representation of a measured value of each of said gathered indicators on a television display.

2. The method of claim 1 wherein said displaying step is accomplished by generating information representative of the gathered indicators of signal quality for display, thereby creating video signal.

3. The method of claim 2 further comprising the step of displaying said video signal on a video display compatible with ATSC high definition standards.

4. The method of claim 2 further comprising the additional step of displaying said video signal on a video display compatible with ATSC high definition standards.

5. The method of claim 2 further comprising the additional step of displaying said video signal on a video display compatible with NTSC standards.

6. The method of claim 1 wherein said displaying step is accomplished by:
generating information representative of the gathered indicators of signal quality, thereby creating a video signal;
providing said video signal to an NTSC radio frequency modulator; and
displaying said video signal on a video display or an analog NTSC television compatible with NTSC standards on a predetermined radio frequency channel.

7. The method of claim 2 wherein said information includes textual information.

8. The method of claim 2 wherein said information includes graphical information.

9. The method of claim 2 wherein said video signal is created using an MPEG-2 decoder.

10. The method of claim 2 wherein said video signal is created using a microprocessor.

11. The method of claim 1 wherein said gathering step is accomplished using information from an 8-VSB demodulator conforming to ATSC terrestrial digital television signal specification, A/53 document.

12. The method of claim 1 wherein said gathering step is accomplished using information from a quadrature amplitude modulation demodulator conforming to digital cable digital television signal.

13. The method of claim 1 wherein said gathering step is accomplished using information from a radio frequency tuner providing channel selectivity and a television receiving antenna.

14. The method of claim 1 wherein said gathering step is accomplished using information derived from at least one equalizer tap weight.

15. The method of claim 14 wherein said gathering step is accomplished using information derived from a sum, a sum of squares or other equivalent or sub-optimum mathematical operation on the error signal from said equalizer tap weight.

16. The method of claim 1 wherein said processing step is accomplished using MPEG-2 video decoder conforming to ATSC digital television specification, A/53 document.

17. The method of claim 1 wherein said processing step is accomplished using a microprocessor.

18. The method of claim 1 wherein said preparing step is accomplished using microprocessor to provide at least two of the signal quality indicators on a high definition video signal.

19. The method of claim 1 wherein said preparing step is accomplished using microprocessor to provide at least two of the signal quality indicators on an analog NTSC video signal.

20. The method of claim 1 wherein said preparing step is accomplished using microprocessor to provide at least two of the signal quality indicators on an radio frequency modulated analog NTSC video signal on a predetermined radio frequency channel number.

21. The method of claim 1 wherein the television signal is 8-VSB ATSC digital terrestrial television signal conforming to ATSC A/53 specification document.

22. The method of claim 1 wherein the television signal is 16-VSB ATSC digital terrestrial television signal conforming to ATSC A/53 specification document.

23. The method of claim 1 wherein the television signal is E-VSB ATSC digital terrestrial television signal.

24. The method of claim 1 wherein the television signal is defined by ATSC digital terrestrial television signal.

25. The method of claim 1 wherein said display of the signal quality indicia is made by a graphical means.

26. The method of claim 1 wherein said display of the signal quality indicia is made by a number means

27. The method of claim 1 wherein said display of the signal quality indicia is made by a graphical means and a number means.

28. An apparatus for determining and displaying signal quality measurements on a television display, comprising:
at least one antenna for gathering radio frequency television signals;
a radio frequency tuner, connected to said at least one antenna for selecting said radio frequency television signals;
a digital demodulator, connected to said radio frequency tuner, for demodulating said selected radio frequency television signals;
a MPEG-2 video decoder, connected to said digital demodulator, for decoding said digitally demodulated radio frequency television signals;
a microprocessor, connected to said digital demodulator and to said MPEG-2 video decoder, for receiving signal quality information and using said representative signal quality information for display; and
a video display, connected to said microprocessor, for displaying said representative signal quality information.

29. The apparatus of claim 28 wherein said microprocessor provides said representative signal quality information to a MPEG-2 video decoder for display.

30. The apparatus of claim 28 wherein said microprocessor uses said signal quality information to create representative signal quality information for display.

31. The apparatus of claim 28 further comprising:
a radio frequency national television system committee (NTSC) modulator, connected to said MPEG-2 video decoder or microprocessor, for modulating in NTSC format said signal quality information for display on a predetermined television channel; and
a national television system committee (NTSC) television for displaying said signal quality information.

32. The apparatus of claim 28 further comprising:
a power measurement means, connected to said radio frequency tuner, for gathering signal quality information.

33. The apparatus of claim 28 further comprising:
a signal-to-noise (SNR) ratio measurement means, connected to said digital demodulator, for gathering signal quality information.

34. The apparatus of claim 28 further comprising:
a bit error rate (BER), packet error rate, or symbol error rate estimation or measurement means, connected to said digital demodulator, for gathering signal quality information.

35. The apparatus of claim 28 wherein said digital demodulator includes at least one equalizer tap weight used to gather signal quality information.

36. The apparatus of claim 28 wherein said digital demodulator includes at least two equalizer tap weights used to gather signal quality information.

37. The apparatus of claim 28 wherein said digital demodulator or microprocessor includes a multi-path distortion measurement or estimation means, connected to said digital demodulator, for gathering signal quality information.

38. The apparatus of claim 28 wherein said multi-path distortion measurement or estimation means includes an equalizer.

39. The apparatus of claim 38 wherein said multi-path distortion measurement or estimation means uses information derived from one of the following:
a) a sum of magnitude;
b) a sum of squares;
c) other equivalent or sub-optimum mathematical operation on the error signal; or
d) the tap weights from said equalizer tap weights.

40. The apparatus of claim 28 wherein said signal quality information contains a graphical representation.

41. The apparatus of claim 28 wherein said representative signal quality information contains a numerical value.

42. The apparatus of claim 28 wherein said representative signal quality information contains a graphical representation and a numerical value.

43. A method of determining and displaying the quality of an over-the-air broadcast high definition television signal on a television display, comprising the steps of:
gathering at least two of the following indicators of signal quality from the television signal:
a) signal strength of the television signal;
b) bit error rate of the television signal;
c) signal-to-noise ratio of the television signal; or
d) channel multi-path distortion of the television signal;
processing each of said gathered indicators of signal quality to create a representation of a measured value of said indicators;
displaying said representation of said measured value on the television display.

44. The method of claim 43 wherein said representation is a numerical value.

45. The method of claim 43 wherein said representation is graphical.

46. The method of claim 45 wherein said representation is a bar graph.

47. The method of claim 43 wherein said displaying step is accomplished using a microprocessor to provide at least two of the signal quality indicia on an radio frequency modulated analog NTSC video signal on a predetermined radio frequency channel number.
